(19) United States
(12) Patent Application Publication
(10) Pub. No.: US 2014/0075311 A1
(43) Pub. Date: Mar. 13, 2014

(54) METHODS AND APPARATUS FOR CONTROLLING AUDIO VOLUME ON AN ELECTRONIC DEVICE

(71) Applicants: Jesse William Boettcher, San Jose, CA (US); Anton M. Davydov, Gilroy, CA (US); Jonathan Anderson Bennett, San Francisco, CA (US); Taido Lantz Nakajima, Cupertino, CA (US); Imran A. Chaudhri, San Francisco, CA (US); Tiffany S. Jon, Cupertino, CA (US)

(72) Inventors: Jesse William Boettcher, San Jose, CA (US); Anton M. Davydov, Gilroy, CA (US); Jonathan Anderson Bennett, San Francisco, CA (US); Taido Lantz Nakajima, Cupertino, CA (US); Imran A. Chaudhri, San Francisco, CA (US); Tiffany S. Jon, Cupertino, CA (US)

(21) Appl. No.: 13/610,693

(22) Filed: Sep. 11, 2012

(51) Int. Cl. G06F 3/01

(52) U.S. Cl. CPC G06F 3/017
USPC 715/716

(57) ABSTRACT

An apparatus and method for facilitating a user's interaction with an electronic device to control selected audio output volumes of the device. The described methods and apparatus facilitate operation of the electronic device with a volume limit for audio content output from one or more ports of the device that is less than the maximum output volume available from the device. A first user input to increase the volume of an audio signal at one or more ports will increase the volume only to an initial volume limit that is less than the maximum output volume available. A visual, non-textual indicator of the availability of additional volume levels will be displayed to a user; and subsequent receipt of a second input to increase the volume of the audio signal will cause an increase in volume beyond the initial volume limit.

The present invention relates generally to methods and apparatus for controlling the volume output from an electronic device; and more particularly relates to methods and apparatus for enabling a specific user input to selectively raise the volume output from an electronic device beyond an initially limited level.

### BACKGROUND

Systems are known for limiting the volume of the audio output on electronic devices to pre-established levels. Such limited volume levels are typically established at levels not expected to cause damage to the hearing of a user; and in some cases such volume limiting is mandated by a governmental authority. For example, the European Union has specified that for some devices, the audio outputs to headphones must be limited to no more than 100 dB, but is to be limited to no more that 85 dB for prolonged listening.

In some systems providing such volume limiting, the audio output level (i.e. volume) is controlled automatically, such that regardless of a user's inputs, the volume will not exceed a predetermined level. Some of these systems change the permitted maximum volume level in response to the amount of time that a listener operates the system at elevated volumes. Some such systems display a textual warning to a user listening at volumes above a threshold volume level. A limitation of such systems is that they fail to provide optimal control of the user, and fail to allow the user to account for individual preferences and/or capabilities (such as impaired hearing). Additionally, for devices having a touch-sensitive interface (such as a touch screen, trackpad, or other similar surface), the user experience would benefit from enabling the user to interact with the device to control the volume relative to a threshold limit intuitively and without the burden of having to read displayed instructions, resulting in a more efficient human-machine interface.

### SUMMARY OF THE INVENTION

The present invention provides new methods and apparatus for facilitating a user's interaction with an electronic device to control selected audio output volumes of the device. In some embodiments this interaction will include inputs provided through a touch-sensitive surface. In other embodiments, these inputs will be provided through voice commands. These methods and apparatus facilitate operation of the electronic device with an initial volume limit for audio output from one or more ports of the device that is less than the maximum output volume available from the device, but also allow selective raising of the volume level above that initial limit.

In accordance with the methods and apparatus using a touch sensitive surface, a first user input through a touch-sensitive surface to increase the volume of an audio signal at one or more ports of the device will only increase the volume to an initial volume limit that is less than the maximum output volume available. A visual, non-textual indicator of the availability of additional volume levels will be shown to the user on the display of the device. As described later herein, this non-textual indicator can take many possible forms, and in many embodiments will include (virtual) “illumination” of regions on the display, such as on depicted interface object “surfaces.” Such illumination can include, in many embodiments, color changes, and/or animations. Subsequent receipt of an appropriate second touch input from a user through the surface to increase the volume of the audio signal will cause an increase in volume beyond the initial volume limit.

In accordance with the methods and apparatus using a voice interface, the control of the volume will be similar to that provided above. However, the user inputs will be received through a microphone in the device, or otherwise associated with the device. Additionally, in some embodiments, audible indicators will be provided to a user. In some embodiments, non-textual, visual indicators will also be provided, in combination with the audible indicators.

### BRIEF DESCRIPTIONS OF THE DRAWINGS

FIGS. 1A-C depict example electronic devices that may be used to implement the new methods and apparatus described herein. FIG. 1A depicts a media player having a touch screen interface; FIG. 1B depicts another form of a media player having touch-sensitive surface that is separate from the device display; and FIG. 1C depicts a electronic device having telephonic capability as well as other audio output functionality, such as audio and audio-video playing capability, and also having a touch screen interface.

FIG. 2 depicts an example flow chart of a method for operating an electronic device having volume limiting capability and a touch-sensitive surface.

FIGS. 3A-F depict example user interface screens suitable for implementing operations as set forth in the example flow chart of FIG. 2, on an electronic device including a touch screen interface.

FIGS. 4A-E depict user interface screens that reflect inputs provided to the electronic device also implementing the user interface of FIGS. 3A-F, where volume adjust inputs are provided through mechanisms other than the touch screen interface.

FIGS. 5A-E depict example user interface screens suitable for implementing operations as set forth in the example flow chart of FIG. 2 on an electronic device having a touch-sensitive surface that is separate from the display.

FIG. 6 depicts a block diagram of an example system that may be used in example electronic devices implementing the functionality of FIG. 2, such as the example devices of FIGS. 1A-C.

FIG. 7 depicts an example flow chart of a method for operating an electronic device having volume limiting capability through use of voice instructions.

### DETAILED DESCRIPTION

The following detailed description refers to the accompanying drawings that depict various details of examples selected to show how the present invention may be practiced. The discussion addresses various examples of the inventive subject matter at least partially in reference to these drawings, and describes the depicted embodiments in sufficient detail to enable those skilled in the art to practice the invention. Many other embodiments may be utilized for practicing the inventive subject matter than the illustrative examples discussed herein, and many structural and operational changes in addition to the alternatives specifically discussed herein may be made without departing from the scope of the inventive subject matter.

In this description, references to “one embodiment” or “an embodiment,” or to “one example” or “an example” mean that the feature being referred to is, or may be, included in at least one embodiment or example of the invention. Separate references to “an embodiment” or “one embodiment” or to “one example” or “an example” in this description are not intended to necessarily refer to the same embodiment or example; however, neither are such embodiments mutually exclusive, unless so stated or as will be readily apparent to those of ordinary skill in the art having the benefit of this disclosure. Thus, the present invention can include a variety of combinations and/or integrations of the embodiments and examples described herein, as well as further embodiments and examples as defined within the scope of all claims based on this disclosure, as well as all legal equivalents of such claims.

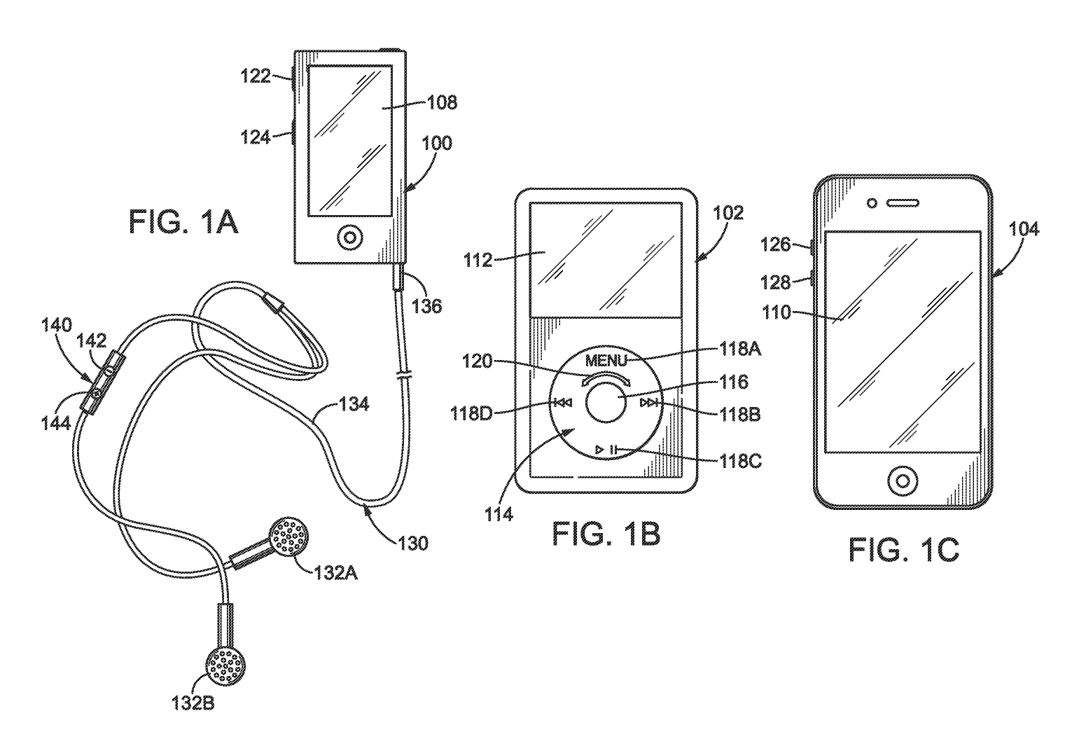

Referring now to the drawings in more detail, and particularly to FIGS. 1A-C, those figures depict three examples of the many forms of electronic devices that can beneficially implement the methods and apparatus described herein. FIG. 1A depicts a portable media player 100, such as an iPod Nano, manufactured by Apple Inc. of Cupertino, Calif. FIG. 1B depicts an alternative configuration of a portable media player 102, such as the Classic model of iPod manufactured by Apple Inc.; and FIG. 1C depicts a smart phone 104, such as the iPhone manufactured by Apple Inc. As will be apparent from the following discussion, many additional configurations of portable electronic devices, and also non-portable electronic devices, may benefit from use of the methods and apparatus described herein.

Each of the depicted portable electronic devices 100, 102, 104 includes a display and a touch-sensitive surface. In the media player 100 of FIG. 1A, and in the smart phone 104, the display and the touch-sensitive surface are combined in a touch screen panel 108, 110, respectively. As is well known in the art, such touch screen panels 108, 110 display information to a user, as well as interactive objects, forming virtual “buttons” or “sliders,” or other forms of control or selection elements. In addition to virtual controls that may be selectively presented through touch screen panels 108, 110 of media player 100 and smart phone 104, these two example devices also include mechanical volume control mechanisms in the form of “volume up” and “volume down” switches (or buttons) 122, 124, respectively, on media player 100, and 126, 128 respectively, on smart phone 104.

Media player 100 is depicted in combination with headphones 130, such as the In-Ear Headphones manufactured by Apple Inc. Such headphones 130 include earbuds 132A, 132B coupled through a cable 134 to a connector 136 configured to engage a conventional headphone port on media player 100 (or on other electronic devices). Each of the example electronic devices, media players 100 and 102, and smart phone 104, includes a headphone port (or “jack”), as is well known in the art. Headphones 130 further include a remote volume control, indicated generally at 140, including both “volume up” and “volume down” buttons 142, 144, respectively. These headphone volume controls may be either mechanically movable buttons or touch-sensitive regions of volume control 140.

In media player 102 of FIG. 1B, the display 112 is separate from the touch-sensitive surface 114. In the depicted example configuration, touch-sensitive surface 114 is implemented as a circular or “race track” surface, forming a virtual scroll wheel. Selected locations on the circular touch-sensitive surface can also be movable and/or deformable to serve as mechanical buttons or switches, as indicated at 118A-D. Alternatively, some or all of such selected locations 118A-D on circular touch-sensitive surface 114 be configured to be responsive to singular touch contacts, for example a “tap,” to serve as virtual buttons or switches. In preferred examples, a central region 116 will serve as either a mechanical or virtual switch, allowing a press or tap input from a user to serve as a “select” function relative to an item or object depicted on display 114. Thus, contact of a user with touch-sensitive surface 114, followed by one or more gestures around the path of that surface, as indicated by arrow 120, may be used to scroll through a list depicted on display 120, or to otherwise move between other forms of interactive objects depicted on display 112. Such interactive objects may then be selected or actuated through one or more of, the switch at central region 116, and/or mechanical or virtual buttons or switches at locations 118A-D.

Many forms of touch inputs are known for interacting with a device through a touch-sensitive surface. Such touch inputs range from single point contacts at a selected location to multi-touch contacts essentially simultaneously at multiple locations; and include both single contact gestures and multiple contact gestures. Accordingly, a wide variety of touch inputs through a touch-sensitive surface are known to those skilled in the art. In the examples of the present description, the inputs are described as single touch inputs, either a single point contact, which may often be of a limited duration such as a “tap” at the selected location, or a single point gesture, involving contact at a selected location and movement of the contact, one example of which would be “dragging” a displayed object along a defined path or to a defined or selected location. Additionally, when the present specification refers to a “contact” or a “gesture” by a user with a touch-sensitive surface, the reference expressly contemplates both direct a contact or gesture, such as through a user's finger or other body part, and an indirect contact or a gesture, such as might be performed through a stylus or similar input device that might be used by a user to contact the touch-sensitive surface.

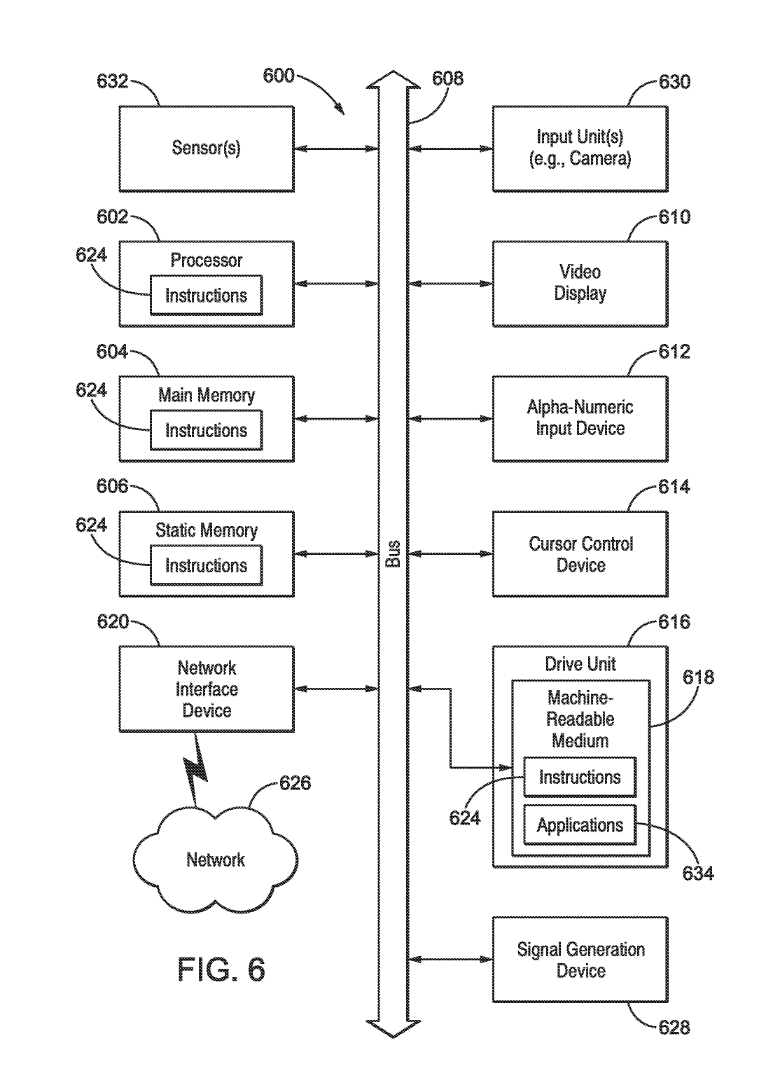

Each of the depcited example portable electronic devices includes one or more processors in operative communication with machine-readable storage devices in the electronic device, which will together be used to execute instructions to provide functionality of the device itself, including functionality as described herein. Each of media player devices 100, 102 and smart phone 104 can also include one or more additional structures, including a power button, a menu button, a home button, a camera, flash source for the camera, one or more input/output jacks or connectors and other components to operate or interface with the device. An example block diagram representation of an architecture suitable for use with any of the portable electronic devices of FIGS. 1A-C is discussed later herein in reference to FIG. 6.

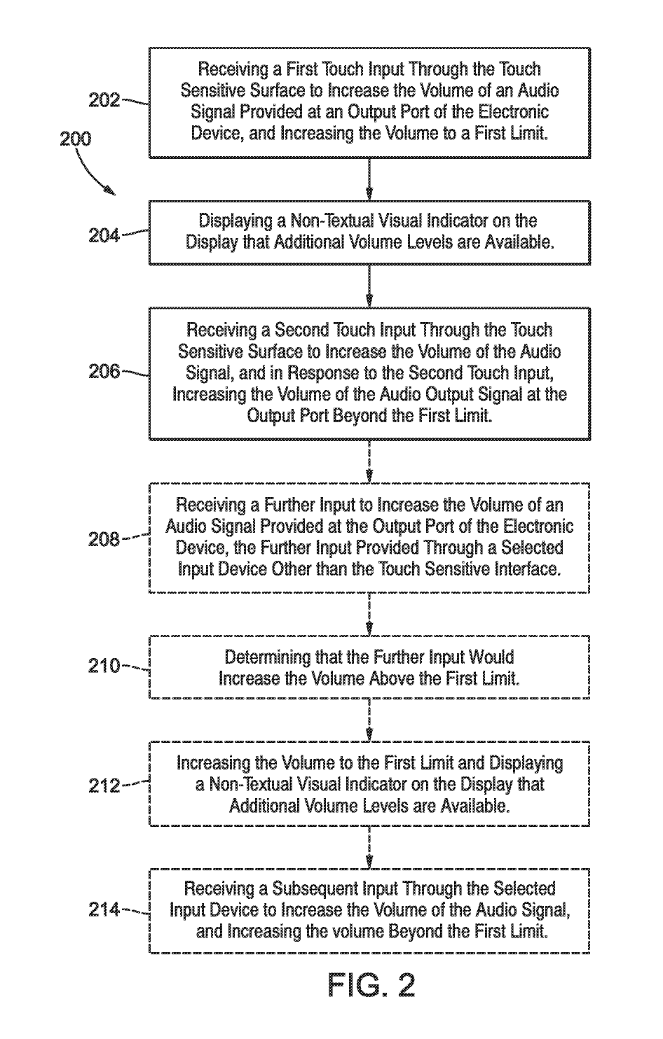

Referring now to FIG. 2, that figure depicts an example flow chart 200 for operation of a volume control system for use on an electronic device having a display and a touch-sensitive input surface, such as any of the example devices described above. The method of the depicted flow chart 200 will be implemented where the device is configured with an output volume established with an initial volume limit, but is configured to allow that limit to be overridden by a user if desired. As depicted at block 202, the device will receive a first touch input through the touch-sensitive surface, the first touch input of a form intended to serve as a volume increase input to the device. In various configurations, this first touch input can be a gesture input, involving movement of a user's contact along a surface of the touch-sensitive surface. Alternatively, the touch input could be configured as a series of touch contacts, such as repeated taps at a single location on the touch-sensitive surface. As one example, the location might be represented by an interactive user interface element such as a “volume up” virtual button presented on the touchscreen.

Whatever the configuration of the first touch input, the volume limit will increase only to the initial volume limit, and will no longer increase in response to that first touch input. Thus, the user will provide an input through the touch-sensitive surface that is consistent with a desire to increase the volume to a desired level that is above the initial volume limit, but the volume level will increase only to that initial volume limit.

Proximate the point at which the established audio volume limit is reached, a visual indicator will be presented to a user through the display. This indicator can be configured to indicate that the volume setting is either approaching or has reached the initial volume limit, and/or that additional volume levels are available, as indicated at block 204. Where the visual indicator will be presented as the audio setting is approaching the initial volume limit, the indicator may be presented at an incremental audio volume setting below the initial limit. Additionally, where such advance warning of an approaching limit is provided, the indicator will preferably change appearance once the limit is reached. In many embodiments, as will be discussed later herein, the visual indicator that the initial limit has been reached will convey that additional audio volume levels are available.

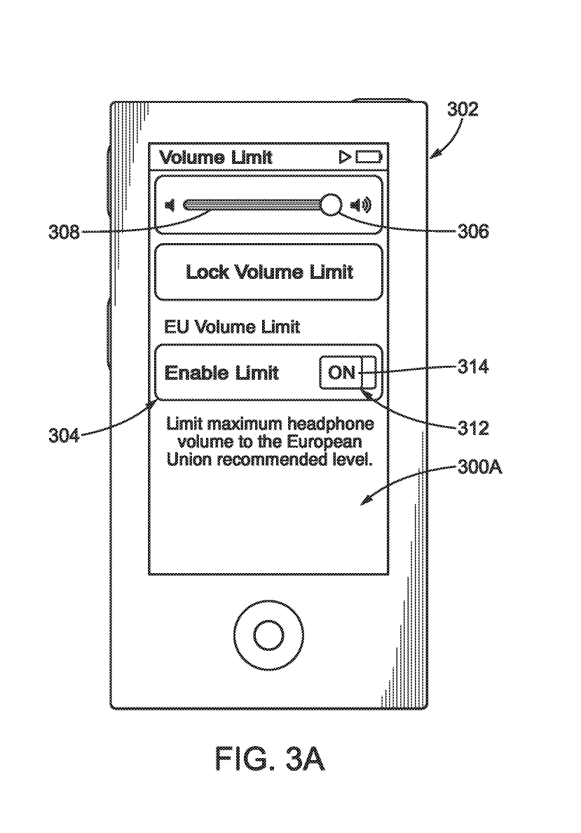

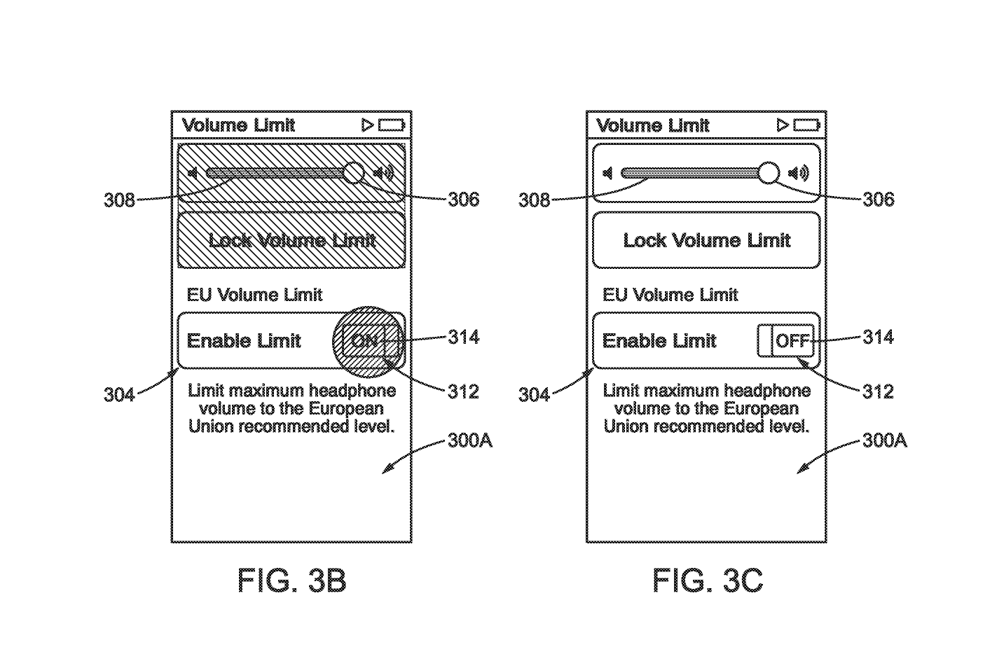

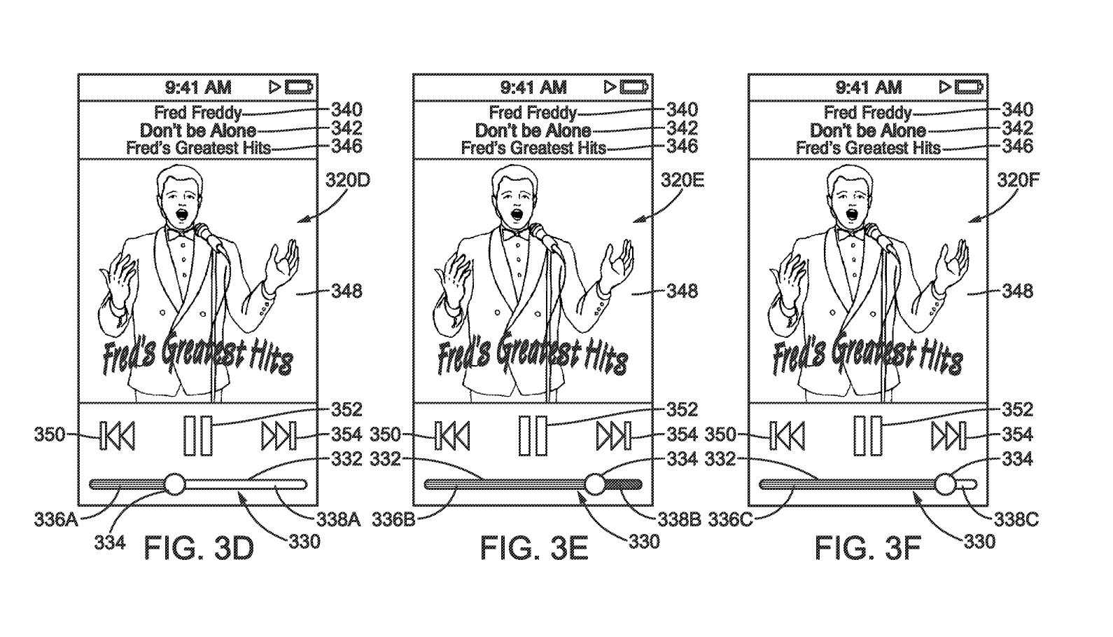

The form of the visual indicator can be one (or more) of many forms. The visual indicator will include at least one non-textual indicator. Such non-textual indicators may be a “lighted” or colored region or surface, of many possible forms, such as a depicted colored bar, a lighted “dot,” etc. Optionally, a textual indicator may be displayed in addition to the non-textual indicator. Such textual indicators can be simple, such as an indication of “high volume,” or can provide instructions to a user as to how to override the established audio volume limit. Preferably, the visual indicator will be of a form that assists the user in providing the appropriate input to override the established audio volume limit, if desired. Examples of such indicators are described below in reference to FIGS. 3D-F.

As indicated at block 206, a second touch input will be received through the touch-sensitive surface, wherein the second touch input is configured increase the volume of the audio signal provided at an output port of the electronic device beyond the first established limit. This second touch input can again take many forms. In order to provide a distinction between the first and second touch inputs, in many implementations, the second touch input will require a break of contact with the touch-sensitive surface. In other examples, the form of the input will change form the first input to the second input, though without a break in such contact (for example the input may change from a single point contact to a multiple point contact without a break of the first contact).

In many embodiments, the first input will include a gesture (as described above) configured to increase the volume, which will then stop increasing at the pre-established first limit. If contact with the touch-sensitive surface is then broken, that will have the effect of terminating the first input. If contact with the touch-sensitive surface is then re-established, after such termination of the first input, the re-established contact represents a second touch contact, and if that second touch input is of a pre-determined type or form (such, for example, as an appropriate gesture), that second touch input will allow increasing of the volume above initial volume limit to the (higher) desired volume level. As just one example, this second touch input may be renewed contact with the touch-sensitive surface, and a continuation of the form of the previously applied first input gesture, as will be addressed in reference to FIGS. 3D-F.

For electronic devices that also include an ancillary mechanical volume control, such as, for example, “volume up” and “volume down” buttons such as may be implemented through mechanical buttons; or which are configured to receive volume controls from attached headphones, also as discussed earlier herein, the method may optionally provide a user interface facilitating the user's overriding of the first established volume limit through inputs provided through that ancillary volume control. Because such additional functionality is optional, the blocks identifying such operations are depicted in dashed lines.

For example, as indicted at block 208, where the mechanical volume control comprises such volume up and volume down buttons, continued holding of the “volume up” button for a sufficient time will result in the audio output volume being increased to the initial volume limit, as discussed above. Alternatively, the volume may be increased incrementally through a repeated series of presses of the “volume up” button, with the increase again stopping at the first established volume limit.

As indicated at block 210, in some embodiments, the system may make a determination as to whether a further increase would be an instruction to increase the volume above the initial limit; and if so, to display the indicator in response to that determination. Regardless of the form of input through the ancillary volume control to increase the volume, as indicated at block 210, proximate the initial volume limit, a non-textual, visual indicator will again be shown on the display. As shown at block 212, once the initial volume limit is reached, if the system receives a further input from a user of an appropriate configuration, that input will be recognized as an instruction to override the initial volume limit. As an example of a suitable configuration for such further input, if the volume is been increased through continual holding of the “volume up” button up to the limit, then a release of the “volume up” button and a repressing of the button may be recognized as an instruction to further increase the volume. If the volume has been incrementally increased through repeated pressing of the “volume up” button, then a sustained holding of the volume up button for a selected duration (for example 1-2 seconds) may be required for the system to recognize the input as an instruction to further increase the volume beyond the established limit.

Referring now to FIGS. 3A-F, those figures depict an example series of user interfaces to implement the above-described method on an electronic device 302 having a touch screen interface. In FIG. 3A the user interface 300A is depicted on an electronic device 302 similar in form to a media player 100 of FIG. 1A. However, the user interface is equally applicable to other electronic devices incorporating a touch screen, such as, for example, smart phone 104 of FIG. 1C. In the depicted examples, each of these devices also includes ancillary volume controls, in the form of mechanical “volume up” and “volume down” buttons, as discussed earlier herein.

FIG. 3A depicts user interface 300A with an example configuration screen 304, facilitating implementation of two alternative methods for establishing a volume limit on media player 302. In an upper portion of the screen, the user has the capability to manually set a volume limit. The limit is established by movement of a slider 306 along a defined path indicated at 308. In the depicted example, slider 306 is at a furthermost right position, or maximum volume position. However, if a user were to provide a touch gesture at the location of slider 306, then dragging it to the left along track 308, that (lower volume) setting can then be retained as a maximum volume limit by a touch contact at the “lock volume limit” interface object 310.

An alternative method of limiting the volume is presented in configuration screen 304 as the “EU volume limit” (in view of the EU established audio volume restrictions identified earlier herein). In some embodiments, the user interface may describe textually that the function of the alternative volume limit is to limit the maximum headphone volume to a defined recommended level. For purposes of the present example, the limit will be discussed as one established by the European Union as a maximum default level for the audio output of a portable electronic device such as media player 302. In most embodiments, this default maximum level for the audio output is applicable only to the audio signal applied to the headphone port on media player 302, and not to other ports to which the audio signal would be provided for playback on devices other than headphones.

The enable limit is selected through use of a user interface object implemented as a virtual slider switch 312 which will switch from the “on” state to the “off” state if moved to the right by sliding switch button back 314 to the right, through a dragging gesture (or because the switch has only two positions, the touch input could be only a “tap” input on button 314). When switch 312 is in the “on” state, the maximum volume will be limited to 85 dB. But when switch 312 is in the “off” state the maximum volume will be initially limited to 85 dB, but as discussed above in reference to flow chart 200, that initial limit may be overridden by a user's second touch input satisfying one or more established conditions.

In some embodiments, only one volume limit mechanism will be used at one time. Thus, a user's selection of one method will cause the other volume limit option to be disabled. In some embodiments, this may be indicated to the user by the unselected volume limit mechanism being shaded or “grayed out” on the display, as depicted in FIG. 3B. In other embodiments, the unselected volume limit option might be removed from the user interface, and then subsequently depicted in the user interface only in response to a user input disabling the previously selected volume limit mechanism.

FIGS. 3A-C depict the configuration interface enabling the “EU volume limit” to be switched from the “on” state in FIG. 3A to the “off” state depicted in FIG. 3C in response to a user touch at the position of sliding virtual button 314 (as depicted in FIG. 3B) configured to result in movement of the button 314 to the off position as depicted in FIG. 3C (as discussed earlier herein). Accordingly, by virtue of actuation of switch 312 to the “off” state, the associated media player 300 will provide an initial volume limit of the audio output signal at the headphone jack to 85 dB, but that limit may be exceeded by an appropriately configured user input.

FIGS. 3D-F depict a media “now playing” user interface screen 300B facilitating user inputs to provide functionalities as discussed in reference to FIG. 2. This “now playing” user interface is displayed when media, such as an audio track, is being played or has been selected for playback. In this example, the “now playing” user interface includes text identifying the performing artist 340, the audio track being played 342 and the “album” containing that audio track 346. As will be readily apparent to those skilled in the art, the “album” can be any collection of audio tracks, including a playlist, etc. Such information is displayed in combination with a graphical representation of artwork, such as, in many implementations, a compact disc cover, or other image associated with the “album” 348. For other audio-containing media, such as movies, music videos, etc., a different screen configuration may be used to display the video content, as is conventionally known.

The user interface provides basic controls for controlling the media play, including an interface element for reversing the playback 350 (or moving to a preceding track), for pausing the playback 352 (or for resuming playback after pausing), and for fast forwarding 354 (or going to a subsequent audio track). Volume control 330 includes a volume track 332 having a slider depicted in the form of a button 334, movable along the predefined path of volume track 332 as identified by segments 336A and 338A behind and ahead of button 334, respectively. As can be seen from FIG. 3D, the appearance of the track segment 336A behind button 334 will preferably have a coloring, shading or other visual indication differing from that of track segment 338A to assist the user's identifying where the volume level is set not only by the position of the button but by the appearance of track segment 336A.

Referring now to FIG. 3E, the user has made contact with the button 334 and has moved it to the right, to a stop position indicating an initial threshold at which the audio volume output to the headphone port of media player 300 is limited. For purposes of the present example, the maximum volume which may be obtained from the device at the headphone port is limited to 100 dB, and thus this stop position of button 334 will be an established initial limit of 85 dB. Accordingly, the length of volume track 332 is representative of the full range of audio output available under the current device settings (here from 0 to 100 dB), and the initial stop position of button 334 provides a proportional representation of the initial threshold limit (at 85 dB) relative to that total volume range.

In this implementation, button 334 will not move any further to the right so long as the user maintains contact with the touch screen at a position corresponding to the button 334. Additionally, user interface 320E provides a non-textual, visual indicator (potentially a warning) as to raising the volume by moving the slider past the designated point. As noted above, this visual indicator can include various forms of visual representations, such as colored indicators designed to catch a user's attention. In the depicted example, this colored indicator is implemented in the remaining portion of track 338B which is beyond the position of slider 334 (which has obviously been moved from the position in FIG. 3D). In preferred examples, this colored indicator is of an attention-attracting color, such as orange, and flashes to catch a user's attention.

As noted above, in order for a user to raise the volume in the depicted example user interface, the user must break contact with the touchscreen, and then provide a new touch input at the location of slider 334, followed by a further gesture to increase the volume limit. In the depicted example, this further gesture may be relatively simple, such as merely dragging slider 334 further along track 332. Other types of gestures could also be used. For example, the further gesture might be a gesture in a new direction oriented away from volume track 332, such as a swiping gesture toward the top of the device, consistent with an indication to raise the volume level. Alternatively, the gesture might include a dragging of slider 334 beyond the end of track 332.

As a further alternative, slider 334 or another user interface object might be dragged from a first position to a second position corresponding to a “high volume” icon. In this last example, slider 334 might be in dragged all the way to the end of volume bar 332, but a non-textual visual indictor can be provided of the availability of additional volume levels if slider 334 is dragged to the location of “high volume” icon (such as, for example, an animation suggesting the appropriate movement). Alternatively, once slider 334 is moved to a position corresponding to the initial volume limit (whether that is only partially along a movement path, or entirely along such a path), then an interactive elements such as the described “high volume” icon may be both visible and selectable by a user (such as through a tap other form of touch input) to allow increasing the volume above the initial limit. Additionally, in such an embodiment, in response to actuation of such a “high volume” icon, either the defined movement path for slider 334 (in FIGS. 3A-E, the length of volume track 332), may extend to depict the additional range; or the length of volume track 332 may remain constant, but the position of slider 334 on volume track 332 may change to reflect the current volume setting level relative to the extended volume limit.

As can be seen in FIG. 3F, in the present example in which the gesture merely requires a renewed contact with slider 334 and dragging of slider 334 further along volume track 332, once the user has reestablished contact with slider 334 and dragged it to the right, no further warning is then shown. Additionally, in the present example, once the user has provided such inputs indicating a conscious election to exceed the initial threshold volume limit, no further visual indicators or warnings will be presented to the user for an established time period.

For example, once the user has made the election to exceed the initial threshold volume limit the user may move the volume above and below that threshold limit without receiving further indicators or warnings for 20 hours of listening above the initial threshold limit, but after such time has elapsed the volume limit will automatically reset to the initial threshold. In many embodiments, only time at which the volume is set above the initial limit will count toward the 20 hour limit. For example, if the user listens for 10 hours with the audio volume set above the initial threshold, and then listens for another 10 hours with the volume set below that initial threshold, and then listens with the volume above the initial threshold for another 6 hours, then the system will not reset the volume limit to the initial threshold for another 4 hours.

In some systems, the volume control operation is configured to provide minimal disruption to the listening experience. And for that reason, the system will evaluate whether the audio being played above the initial limit would result in the resetting of the audio level to that initial limit in a manner that would interrupt the delivery of audio to a user. For example, if a user were to have accumulated over hours of listening above the initial audio limit, for example, 18 hours; and were then to initiate playback of a two-and-a half hour movie, with the audio limit set above the initial limit, the system would reset the audio limit to the initial limit at the start of playback of the movie. This would avoid a sudden drop in volume during the playback (when the 20 hours “timed out”), thereby improving the user experience.

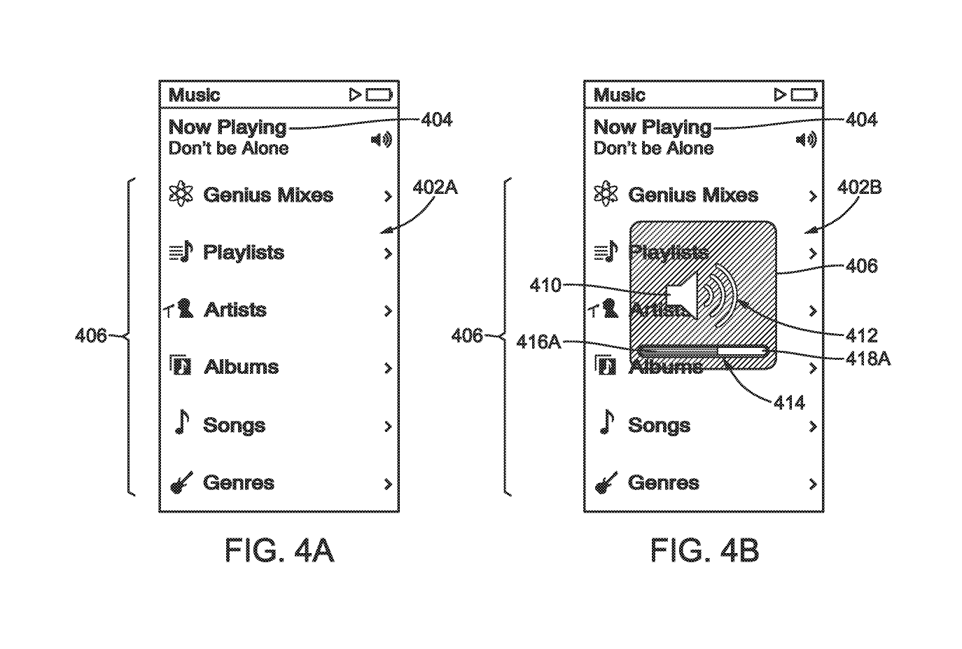

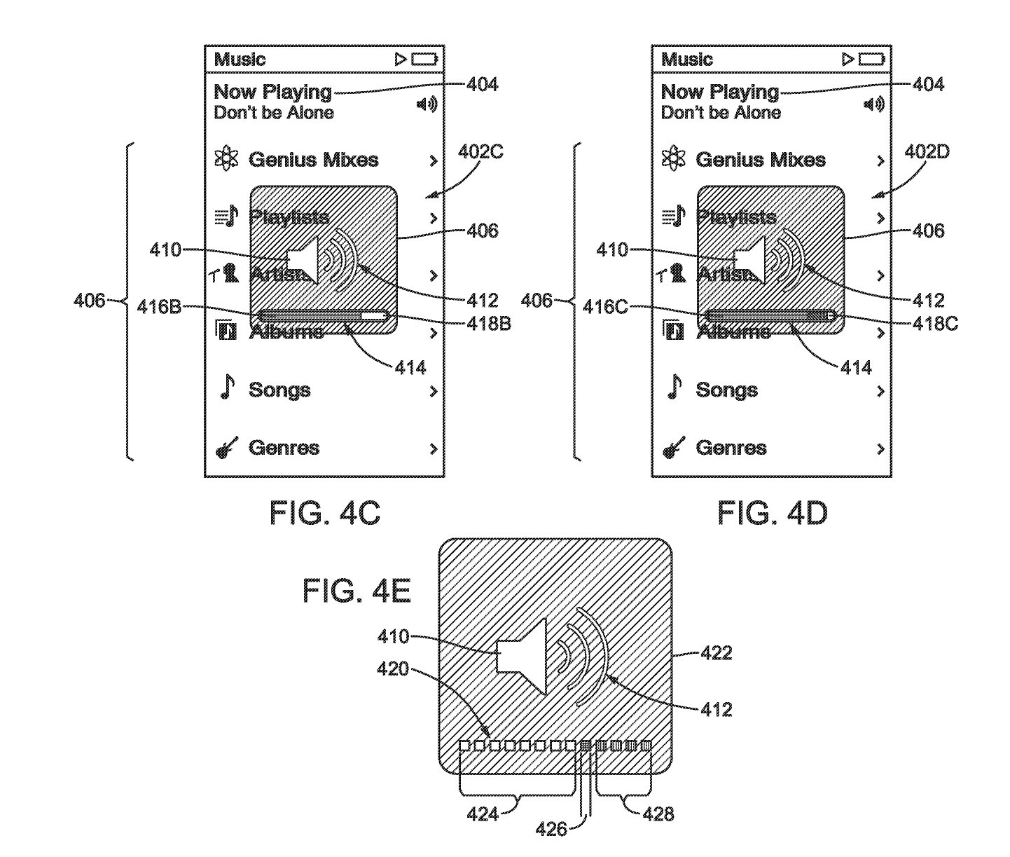

Referring now to FIGS. 4A-D, therein is depicted another user interface 400 also useful with devices such as those depicted in FIGS. 1A and C. These devices, in addition to having volume controls on the user interface, also facilitate the changing of volume levels by ancillary controls, such as mechanical switches. FIG. 4A depicts a user interface 400 with a screen 402 identifying an audio track being played 404, in combination with a plurality of categories or groupings of audio tracks 406, which may be used to locate additional audio tracks of interest. User interface 400 depicts example screen 402 before any adjustments to volume are made.

FIG. 4B depicts user interface 400 after a user has pressed a “volume up” button one or more times. In this case, a notification region 406 is superimposed over user interface 402 providing an indication that the volume level is being increased. In many embodiments, this notification region 406 will differ from the user interface for touch screen inputs by providing only notification to a user, with no interactive objects. In the depicted example there is a representation of a speaker 410 with a plurality of arcuate waves, suggestive of soundwaves, indicated generally at 412, emanating from the depicted speaker. As volume is increased more waves can be depicted at 412 and as the volume is decreased fewer waves can be depicted, thereby providing a visual indicator of the general volume level. Additionally, a volume bar 414 is depicted wherein a “set volume” region 416A extends from the left (i.e. extends from a “0 volume” position) indicating the relative level to which the audio volume has been set through use of the external buttons. Volume bar 414 is presented with differing appearance of region 416A relative to the remainder 418A of volume bar 414. This differing appearance will typically include at least a different, and easily viewable, coloration of region 416A.

Referring now to FIG. 4C, in response to “volume up” inputs through the mechanical controls, the displayed volume level will max out at a position corresponding to the predefined 85 dB level as discussed earlier herein, as indicated by the “set volume” region 416B of volume bar 414. in most embodiments, as depicted in FIG. 4D, user interface 400 will then display a visual, non-textual indicator of the availability of additional volume level settings. This indicator will often include at least a contrasting appearance of the remaining region 418C of volume bar 414, which, in a manner analogous to that discussed previously with respect to FIGS. 3D-F, will include at least a contrasting color, and may also include some form of animation, such as a flashing of some portion or all of remaining region 418C of volume bar 414. Also as noted previously, some textual message or instruction may also he displayed to a user in combination with the non-textual indicator.

At this point, as with the touch screen implemented control, the user must take some specific action to instruct the system to exceed the established initial volume limit. For example, the user may have to release the volume up switch and then press it again in order to provide an affirmative indication of the intent to establish threshold; or may need to press the volume up switch for a predetermined period for the system to recognize the input as an instruction to exceed the initial volume limit. Once the system has recognized an input appropriately configured to indicate to the system a user's intent (or “opt-in”) to exceed the initial audio limit, then that input will allow control of the volume above and below the initial level through either the touchscreen control or the mechanical switch controls. In systems implementing a time control, as discussed above, that control will monitor the time spent above the initial audio limit without regard for the control used to change the volume.

FIG. 4E depicts an alternative configuration for a volume indicator 420, depicted here in the context of a notification region 422. The volume indicator is equally applicable to use in other contexts. In place of a continuous volume track, volume indicator 420 includes a plurality of discrete elements, such as geometric elements, that can change appearance to indicate volume level information. In the depicted example, a first segment 424 of the group of discrete elements can reflect a first color indicating a volume level setting below a threshold (at least by some margin). In this example, at an increment level below an initial volume threshold, indicted at 426, the element(s) will reflect a second, contrasting color, indicating that the volume level is approaching the initial limit. Once the volume level is raised to the initial limit, the remainder of the elements 428 can indicate the limit, such as by reflecting a different color, such as red. As discussed earlier herein, any portion of the elements, such as group 428, can also be depicted with various forms of animation (flashing, changing colors, sequential changes, etc.).

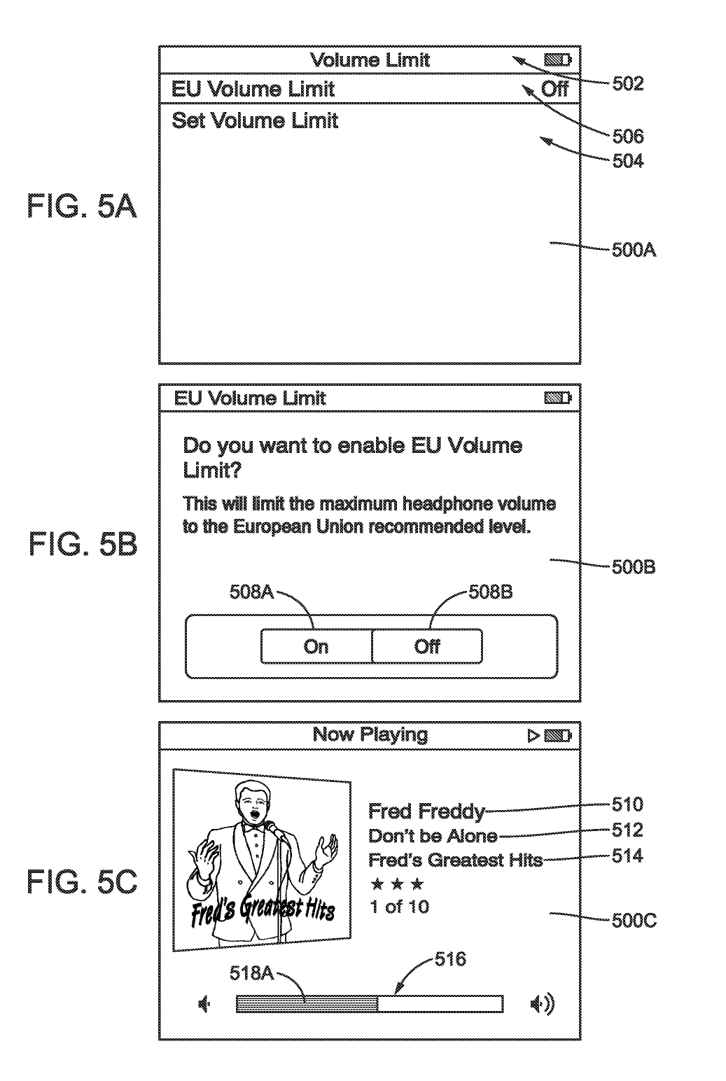

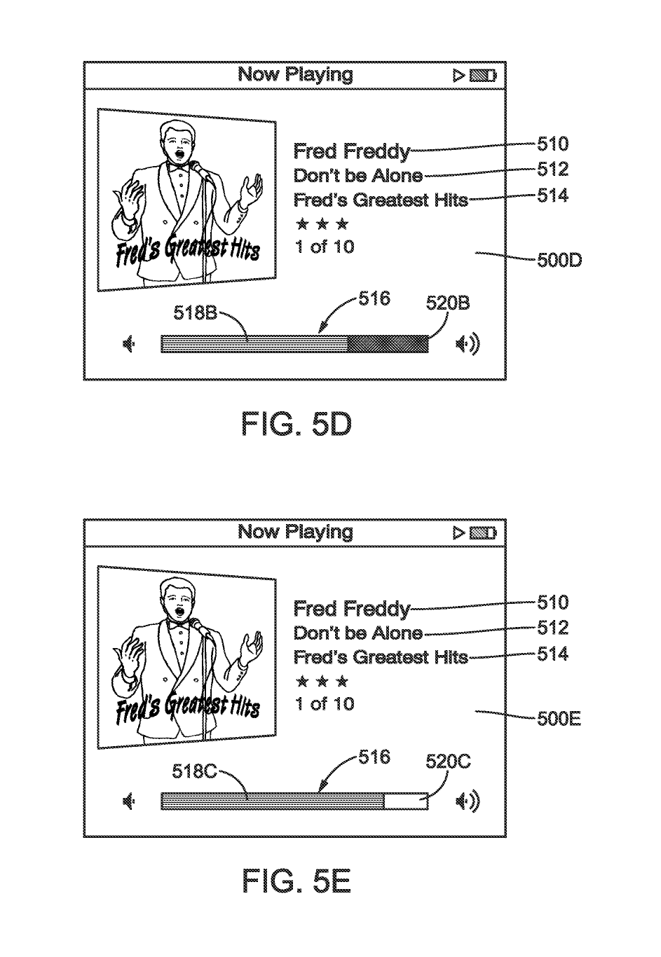

Referring now to FIGS. 5A-E, those figures depict a user interface 500 having screens 500A-E suitable for use with a device having a touch-sensitive interface other than a touch screen display as in the embodiments discussed above. Accordingly, user interface 500 is configured to be useful, for example with a device such as the Classic model iPod, as depicted at 102 in FIG. 1B, in which display 112 is separate from touch-sensitive surface 114.

As is known to those skilled in the art, electronic device 102 will have various menus for accessing various functionality of the device, including operational settings. FIG. 5A depicts interface screen 500A indicating that a volume limit menu 502 has been accessed. As with the system as discussed in reference to FIGS. 3A-C, the menu provides option for manually setting a volume limit 504, as well as for selectively implementing a prescribed a volume limit, indicated again as the “EU Volume Limit” as indicated at 506. As with that system, enabling the EU Volume Limit will automatically restrict the maximum audio volume at the headphone port to 85 dB; while disabling that limit will enable the intentional raising of the volume level above that limit through appropriate inputs through touch-sensitive interface 114. As is familiar to persons skilled in the art, a user may move between the two displayed volume limit options 504, 506 through a gesture movement along the path of touch-sensitive interface 114 of device 102 (as depicted in FIG. 1B) to highlight the desired option; and may then select that option through actuation of the button in central region 116 of that device.

Once the EU Volume Limit option has been selected, as depicted in FIG. 5B, once again, the user may move between the “on” and “off” user interface elements 508A, 508B through a gesture movement on touch-sensitive interface 114, and may again select the desired option through the button of central region 116.

Screen 500C of FIG. 5C depicts a “now playing” screen, identifying the performer 510, the track playing 512 and the album containing that track 514. Screen 500C also depicts a volume bar 516 within indicator of the relative volume level setting, as depicted by region 518A. On screen 500C. the volume level is set to a moderate level, at about 50% of the possible output. The volume bar function and display can be directly comparable to that depicted and described relative to FIGS. 4B-E.

Referring now to FIG. 5D, once the user provides a “volume up” input by a clockwise gesture movement around the path of touch-sensitive interface 114, at the point that the output level reaches the initial stop at 85 dB, the volume level will cease to increase in response to that user input. However, the availability of additional volume levels will be indicated to a user by a visual, non-textual indicator, such as coloration of region 520B of volume bar 516 extending above the initial stop position. As previously discussed, region 520B may be filled in with a contrasting color configured to attract the users attention, and may also include some animation, such as flashing of the region, or of flashing between two colors. Another form of suitable animation might be sequential filling in of additional segments of region 520B in a manner suggesting movement to the right, toward the maximum volume limit of volume bar 516.

For a user to exceed the initial limit level, a second touch input can be provided by the user's breaking of contact with touch-sensitive region 114, and then renewing that contact with a continued clockwise gesture movement around that region, resulting in a further increase in volume to a desired level, as depicted in FIG. 5E.

Similar principles can be applied to devices that do not include a display or a touch sensitive surface, such as the iPod Shuffle from Apple Inc. For example, in response to user inputs increasing the volume, such as through inputs through switches on associated headphones, the volume increase will stop at an initial limit, as described earlier herein. If a visible indicator is present, such as a status light (such as an LED), the light may be illuminated in a manner to signal the limit to a user. Such illumination can be by color, or by periodic illumination (such as flashing), or by some combination of the two (such as flashing between two alternating colors). Additionally, the illumination can be of one form (such as one color) when the initial limit is reached, and of another form (such as another color), if the initial limit is exceeded. Additionally, in many embodiments it will be desirable to provide audible indications of the volume limit to a user. While the audible indications may be of many possible forms, some indications to a user will often be a “spoken” voiceover message communicated to the user through the headphones. For example, upon the volume being raised to the initial limit, an audible cue, such as a “chirp” or “beep” may signal the reaching of the limit; and upon a further appropriate volume increase input (such as a release and re-actuation of a volume increase mechanism), a voiceover message, such as “high volume” may be presented to a user.

Additionally, at least for such media players without displays, the option to configure the device to enable or disable the capability to exceed the initial volume limit can advantageously be provided through a configuration interface presented on a “host device,” such as a computer to which the media player is coupled. This form of configuration interface through a host device is known, for example, through the host user interface provided through the iTunes application from Apple Inc. for the iPod Shuffle. In the case of the volume limit functionality, such host interface can provide user selections comparable to one or more of the selections as discussed in reference to FIGS. 3A-C herein. This form of host-based configuration screen can also be implemented with any form of portable device, such as the devices described herein.

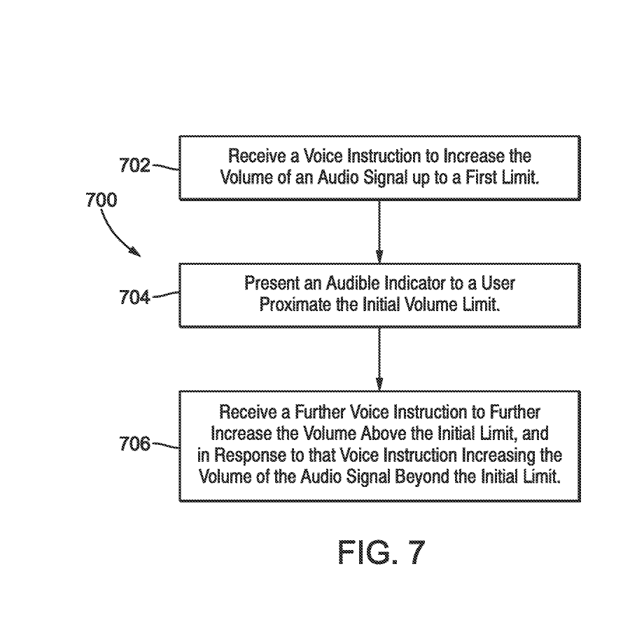

Referring now to FIG. 7, the above-discussed embodiments address user inputs to increase volume limits through either (or both) of a touch-sensitive surface (which may be a touch screen) and an ancillary input mechanism such as mechanical controls on the device or controls on headphones associated with the device. Another alternative input functionality that may be used with many embodiments of electronic devices such as the examples discussed herein, is voice input for the commands, as described in reference to example flow chart 700, of FIG. 7. In such systems a user's voice instruction is received through a microphone, either in the device itself or in headphones associated with the device, and the command is processed to control the device to provide the appropriate functionality. The systems for receiving and processing such inputs are known to those skilled in the art. The Siri™ functionality provided in some portable devices manufactured by Apple Inc. is an example of one such known system.

With such systems, a user can speak a command, such as “increase volume” or “volume up” to increase the output volume from the device. Each such input will result in an incremental increase of volume in the same manner that would result from a discrete push of a volume button. Subsequent inputs of the same command, or perhaps an alternative truncated command, such as “increase,” would result in further incremental increases up to the initial limit, in the manner discussed earlier herein, as indicted at block 702. An indicator may again be presented to a user, which can include any appropriate non-textual visible indicator such as any of the examples discussed herein and/or an audible indicator, as indicated at block 704, as in reference to the embodiment immediately above. In keeping with the voice-based interaction provided for the inputs, the system could provide a voiceover message proximate the limit, such as “approaching volume limit” if before the limit, or such as “volume limit reached” if at the limit. Additionally, as noted above, the system could provide a prompt as to how to further increase the volume. Such prompt could be in the form of another voiceover message, such as “to increase to high volume range, say ‘increase past limit.’” Alternatively, in keeping with the interpretive functionality provided by voice-based user interface systems such as Siri, the system night interpret multiple forms of spoken natural language inputs as instructions to increase the volume above the initial limit. Alternatively, the system might respond to an instruction relative to a specific volume setting, such as “increase to level 10.” When such voice instruction is received, the system will increase the device volume above the initial limit to the extent instructed by the command.

FIG. 6 illustrates a block diagram representation of an example architecture for electronic devices 600 that can beneficially implement the described methods and apparatus, including any of the electronic devices of FIGS. 1A-1C. Many configurations for electronic device 600 will include one or more processors which will operate pursuant to one or more sets of instructions for causing the machine to perform any one or more of the methodologies discussed herein, as well as additional functionalities.

Example electronic device 600 includes at least one processor 602 (e.g., a central processing unit (CPU), a graphics processing unit (GPU) or both), a main memory 604 and a static memory 606, which communicate with each other via a bus 608. The example electronic device 600 further includes a video display unit 610 which may he discrete, such as a liquid crystal display (LCD), an organic light emitting diode (OLED) display, etc., or may a portion of a capacitive sensing or other form of a touch screen panel. In some embodiments, example electronic device 600 also includes one or more additional input mechanisms 630 (e.g., a camera, a machine readable information reader, etc.) and sensor(s) 632 (e.g., an angular velocity sensor such as a gyroscope, an accelerometer, a global positioning system (GPS) unit, headphone control receivers, and/or other device state or motion sensors); and may include related units such as a light flash source for the camera. In many embodiments, the electronic device 600 will also include an alphanumeric input device 612 (e.g., a keyboard, which may be either mechanical or virtual), a cursor control device 614 (e.g., a mouse, a track pad or other touch-sensitive surface, etc.), a disk drive unit 616, a signal generation device 628 (e.g., a speaker), and a network interface device 620 (e.g., a transceiver, a WiFi transceiver, a cellular transceiver, etc.).

The disk drive unit 616 includes a machine-readable medium 618 on which is stored one or more sets of executable instructions 624, in some cases grouped as applications 636 embodying any one or more of the methodologies or functions described herein. In place of the disk drive unit, a solid-state storage device, such as those comprising flash memory (or another form of generally non-volatile storage) may be utilized. The executable instructions 624 may also reside, completely or at least partially, within the main memory 604 and/or within the processor 602 during execution thereof by the electronic device 600, the main memory 604 and the processor 602 also constituting machine-readable media and machine-readable devices. Alternatively, the instructions may be only temporarily stored on a machine-readable device within electronic device 600 proximate the time of execution, and until such time may stored externally, and received over a network 626 via the network interface device 620.

While the machine-readable medium 618 is shown in an example embodiment to be a single medium, the term “machine-readable medium” as used herein should be taken to include all forms of storage devices, either as a single medium or multiple device, in all forms; e.g., a centralized or distributed database storage mechanism and/or associated caches and servers; one or more storage devices, such as storage drives (including e.g., magnetic and optical drives and storage mechanisms), and one or more instances of memory devices or modules (whether main memory, cache storage either internal or external to a processor, or Buffers. The term “machine-readable medium” or “computer-readable medium” shall be taken to include any tangible non-transitory device which is capable of storing or encoding a sequence of instructions for execution by the machine and that cause the machine to perform any one of the methodologies. The term “non-transitory medium” expressly includes all forms of storage devices, including drives (optical, magnetic, etc.) and all forms of memory devices (e.g., DRAM, Flash (of all storage designs), SRAM, MRAM, phase change memory, etc., as well as all other structures designed to store information of any type for later retrieval.

Many modifications and variations may be made in the techniques and structures described and illustrated herein. Accordingly, it should be readily understood that the examples provided herein are illustrative only, and should not be considered as limitations on the scope of the present invention, which is defined only by the scope of claims based upon the support of the present specification.

1. A method of controlling an electronic device having a display and a touch-sensitive input surface, comprising:
receiving a first touch input through the touch-sensitive surface to increase the volume of an audio signal provided at an output port of the electronic device, wherein the volume increases to a first limit that is less than the maximum volume the electronic device is able to supply at the port;
displaying a non-textual visual indicator on the display that additional volume levels are available; and
receiving a second touch input through the touch-sensitive surface to increase the volume of the audio signal provided at an output port of the electronic device; and
in response to receiving the second touch input, increasing the volume of the audio output signal at the output port beyond the first limit.

2. The method of claim 1, wherein the touch-sensitive input surface and the display are formed as a touch screen interface.

3. The method of claim 1, wherein the volume of the audio signal output level of the device is indicated by an audio volume indicator depicted on the display of the device, and wherein the non-textual visual indicator is depicted as a portion of the audio volume indicator.

4. The method of claim 3, wherein the non-textual visual indicator comprises a region of contrasting color relative to an indication of the established audio volume.

5. The method of claim 4, wherein he non-textual visual indicator further comprises an animation.

6. The method of claim 3, further comprising a textual indicator that the output volume is set to a level above the initial limit.

7. The method of claim 1, wherein the volume will reset to the first limit after operation for a predetermined period at a volume level in excess of the initial limit level.

8. An electronic device, comprising:
one or more processors;
a display in operative communication with at least one processor;
a touch-sensitive input surface in operative communication with at least one processor;
a machine-readable memory comprising instructions that when executed by at least one processor perform operations comprising,
receiving a first touch input through the touch-sensitive surface to increase the volume of an audio signal provided at an output port of the electronic device, wherein the volume increases to a first limit that is less than the maximum volume the electronic device is able to supply at the port;
displaying a non-textual visual indicator on the display that additional volume levels are available; and
receiving a second touch input through the touch-sensitive surface to increase the volume of the audio signal provided at an output port of the electronic device; and
in response to receiving the second touch input, increasing the volume of the audio output signal at the output port beyond the first limit.

9. The electronic device of claim 8, wherein the operations further comprise:
receiving an input to increase the volume of an audio signal provided at an output port of the electronic device through an selected input device other than the touch-sensitive surface, wherein in response to such input the volume will increase only to the first limit;
displaying an indicator on the display that additional volume levels are available;
receiving a second input through the selected input device to increase the volume of the audio signal provided at an output port of the electronic device beyond the first limit; and
in response to the second input through the selected input device, increasing the volume of the audio signal beyond the first limit.

10. The electronic device of claim 8, wherein the touch-sensitive input surface and the display are combined as a touch screen interface, and wherein the first and second touch inputs are received through the touch screen interface.

11. The electronic device of claim 8, wherein the operations further comprise indicating the volume of the audio signal output level of the device by an audio volume indicator depicted on the display of the device, and depicting the non-textual visual indicator as a portion of the audio volume indicator.

12. The electronic device of claim 11, wherein the non-textual visual indicator comprises a region of contrasting color relative to an indication of the established audio volume.

13. The method of claim 12, wherein the non-textual visual indicator further comprises an animation.

14. The electronic device of claim 11, the operations further comprise displaying a textual indicator that the output volume is set to a level above the initial limit.

15. The electronic device of claim 8, wherein the operations further comprise resetting the volume to the first limit after operation for a predetermined period at a volume level in excess of the initial limit level.

16. A machine-readable memory device comprising instructions for operating an electronic device having a display and a touch-sensitive surface, wherein the instructions, when executed by at least one processor, cause the electronic device to perform operations, comprising:
receiving a first touch input through the touch-sensitive surface to increase the volume of an audio signal provided at an output port of the electronic device, wherein the volume increases to a first limit that is less than the maximum volume the electronic device is able to supply at the port;
displaying a non-textual visual indicator on the display that additional volume levels are available; and
receiving a second touch input through the touch-sensitive surface to increase the volume of the audio signal provided at an output port of the electronic device; and
in response to receiving the second touch input, increasing the volume of the audio output signal at the output port beyond the first limit.

17. The machine-readable memory device of claim 16, wherein the operations further comprise:
receiving an input to increase the volume of an audio signal provided at an output port of the electronic device through an selected input device other than the touch-sensitive surface, wherein in response to such input the volume will increase only to the first limit;
displaying an indicator on the display that additional volume levels are available;
receiving a second input through the selected input device to increase the volume of the audio signal provided at an output port of the electronic device beyond the first limit; and
in response to the second input through the selected input device, increasing the volume of the audio signal beyond the first limit.

18. The machine-readable memory device of claim 16, wherein the touch-sensitive input surface and the display are combined as a touch screen interface, and wherein the first and second touch inputs are received through the touch screen interface.

19. The machine-readable memory device of claim 16, wherein the operations further comprise indicating the volume of the audio signal output level of the device by an audio volume indicator depicted on the display of the device, and depicting the non-textual visual indicator as a portion of the audio volume indicator.

20. The machine-readable memory device of claim 19, wherein the non-textual visual indicator comprises a region of contrasting color relative to an indication of the established audio volume.

21. The machine-readable memory device of claim 20, wherein the non-textual visual indicator further comprises an animation.

22. The machine-readable memory device of claim 19, the operations further comprise displaying a textual indicator that the output volume is set to a level above the initial limit.

23. The machine-readable memory device of claim 16, wherein the operations further comprise resetting the volume to the first limit after operation for a predetermined period at a volume level in excess of the initial limit level.

24. An electronic device, comprising:
one or more processors;
a display in operative communication with at least one processor;
a touch-sensitive input surface in operative communication with at least one processor;
a machine-readable memory comprising instructions that when executed by at least one processor perform operations comprising,
receiving a first touch input through the touch-sensitive surface to increase the volume of an audio signal provided at an output port of the electronic device, wherein the volume increases to a first limit that is less than the maximum volume the electronic device is able to supply at the port;
indicating the volume of the audio signal output level of the device by an audio volume indicator depicted on the display of the device, and presenting an animated, non--textual, visual indicator as a portion of the audio volume indicator that additional volume levels are available; and
receiving a second touch input through the touch-sensitive surface to increase the volume of the audio signal provided at an output port of the electronic device;
in response to receiving the second touch input, increasing the volume of the audio output signal at the output port beyond the first limit;
receiving an input to increase the volume of an audio signal provided at an output port of the electronic device through a selected input device other than the touch-sensitive surface, wherein in response to such input the volume will increase only to the first limit;
displaying an indicator on the display that additional volume levels are available;
receiving a second input through the selected input device to increase the volume of the audio signal provided at an output port of the electronic device beyond the first limit; and
in response to the second input through the selected input device, increasing the volume of the audio signal beyond the first limit.

25. The electronic device of claim 24, wherein the operations further comprise resetting the volume to the first limit after operation for a predetermined period at a volume level in excess of the initial limit level.

26. A method for adjusting the volume on a device having a touch-sensitive surface, comprising:
increasing the volume to a predetermined volume level less than a desired volume level in response to a first input received on the touch-sensitive surface to increase volume to the desired volume level, wherein a non-textual indicator is displayed once the volume reaches the predetermined level;
detecting that the first input is terminated; and
increasing the volume from the predetermined volume level to the desired volume level, in response to a second input received on the touch-sensitive surface to increase volume to the desired volume level, wherein the second input occurs subsequent to termination of the first input.

27. The method of claim 26, wherein the touch-sensitive surface is a touch screen.

28. A machine-readable memory device comprising instructions for operating an electronic device having a display and a touch-sensitive surface, wherein the instructions, when executed by at least one processor, cause the electronic device to perform operations, comprising:
increasing the volume to a predetermined volume level less than a desired volume level in response to a first input received on the touch-sensitive surface to increase volume to the desired volume level, wherein a non-textual indicator is displayed once the volume reaches the predetermined level;
detecting that the first input is terminated; and
increasing the volume from the predetermined volume level to the desired volume level, in response to a second input received on the touch-sensitive surface to increase volume to the desired volume level, wherein the second input occurs subsequent to termination of the first input.

29. The machine-readable memory device of claim 28, wherein the inputs received on the touch-sensitive surface are received on a touch screen.
